(19) United States
(12) Patent Application Publication
(10) Pub. No.: US 2017/0347802 A1
(43) Pub. Date: Dec. 7, 2017

(54) Disposable & Recyclable Protective Seat Covering

(71) Applicant: Ryan Hatfield, Charleston, WV (US)

(72) Inventor: Ryan Hatfield, Charleston, WV (US)

(21) Appl. No.: 15/170,642

(22) Filed: Jun. 1, 2016

(51) Int. Cl. A47C 7/62; A47C 1/12; B64D 11/06

(52) U.S. Cl. CPC A47C 7/386; A47C 7/62; B64D 11/0646; A47C 1/12

(57) ABSTRACT

This invention relates to disposable and recyclable protective coverings for the top portion of a seat, such as those found in cinemas, theaters, and airplanes. The Disposable and Recyclable Protective Seat Covering consists of a belt, which fits to most seats, and a strap that runs overtop the seat and fastens on the back of the belt. The belt contains a raised head guard for user protection and comfort, and a pocket for storing small valuables. Also, an optional drape hangs from the belt and covers the front of the seat.

### BACKGROUND OF INVENTION

### A. Field of Invention

This invention relates generally to seat covers. More specifically, the invention relates to disposable and recyclable protective coverings for the top portion of a seat such as those found in cinemas, theaters, and airplanes.

### B. Background

The invention provides numerous benefits and advantages over known seat covers. In particular, the invention utilizes a reliable height adjustment function that allows for full coverage of sensitive portions of the human body, such as the head, hair, and neck areas, while avoiding coverage of those areas not necessitating coverage, such as the back, arms, buttocks, and legs. Thus, bulkiness and waste of materials is avoided, resulting in optimal comfort with little noise and lowered user costs.

A practical example of the flexibility possessed by the invention resides in its ability to allow the invention to be used by either a short or tall individual for optimal coverage. The height adjustment function allows the cover to be lowered to protect the sensitive areas of the body of a short individual or to be raised to protect the sensitive areas of the body of a tall individual, while avoiding bulkiness and unnecessary coverage of areas not necessitating protection.

In addition to the foregoing attributes, the seat cover possesses numerous other benefits over conventional devices. The seat cover provides a pocket for holding and securing devices, such as a cell phone or wallet, allowing the user to gain immediate access to such items with limited movement. The seat cover may also be comprised of recyclable nonwoven materials to allow for the easy and responsible disposal of the seat cover. It can thus be seen that the present invention provides a novel seat cover, which successfully and comfortably covers only the sensitive areas of the body of an individual of any size allowing for a reduction in bulkiness and waste.

### BRIEF SUMMARY OF THE INVENTION

The present invention is directed at apparatus and methods for covering the top portion of a seat. The inventive subject matter, or body, considers the covering of the top portion of seats and generally comprises the following steps: providing a belt that fits and secures around the upper back portion of a seat; providing elastic and straps to allow for the adjustment of the belt; providing a drape attached to the body for additional coverage; providing a pocket attached to the body for storage (claims 1-8).

### DESCRIPTION OF SEVERAL VIEWS OF DRAWINGS

Various other objects, features, and advantages of the invention will become better understood when considered in conjunction with the accompanying drawings, in which the markers below (i.e. FIG. 1) represent the several views of the invention located within the drawings:

FIG. 1 is a front view of invention.

FIG. 2 is a side-perspective view of the present invention.

FIG. 3 is a top-perspective view of the present invention.

FIG. 4 is a bottom-perspective view of the present invention.

### DESCRIPTION OF PREFERRED EMBODIMENT

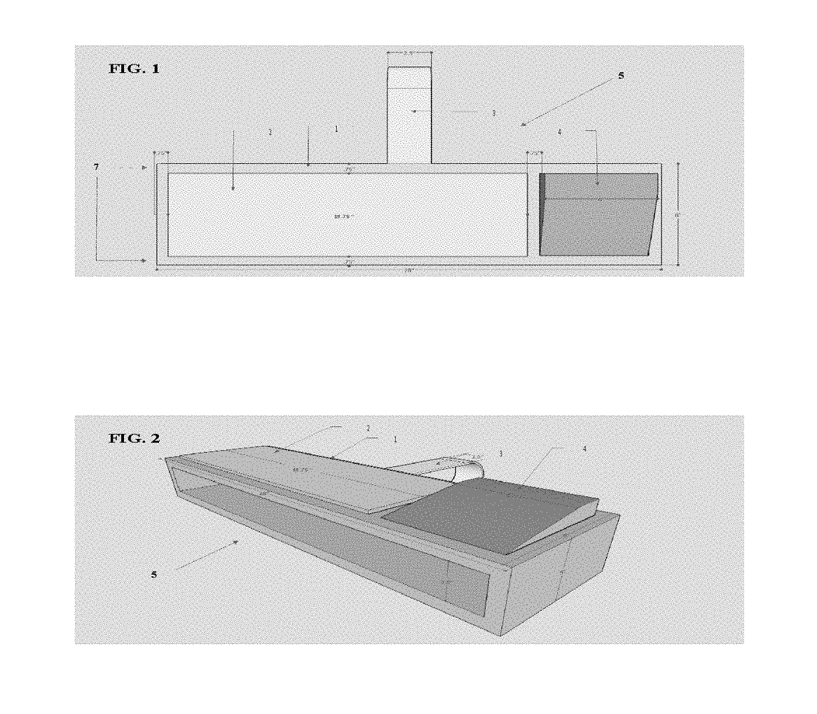

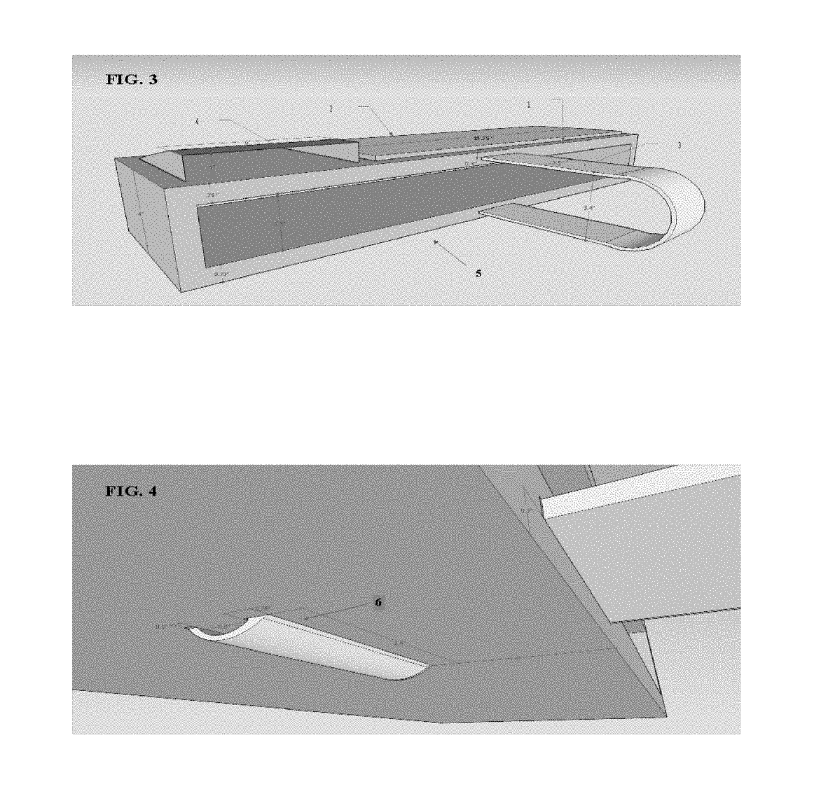

The following descriptions concern the drawings, in which similar references denote similar elements throughout the several views. FIG. 1 through FIG. 4 illustrate a disposable head protector 5 comprising a nonwoven, recyclable fabric belt 1 that fits around the top portion of a seat, and a strap 3 that fastens to the top front of the belt 1 and extends over the top-center of the seat; the strap 3 is looped through a double entry slot 6 located on the backside of the belt 1. On the front of said belt 1, a head guard 2, raised one-tenth (0.10) inch, and a pocket 4 positioned above user's left shoulder. Located inside the belt 1, two elastic bands 7 run the top and bottom dimensions.

A singular strap 3 is attached to the top portion of the belt 1, which serves to further secure the head protector 5 to a seat. The strap 3 runs over top a seat to the back of a seat, and is looped through double entry slots 6 located on the backside of the belt 1. As best shown in FIG. 4 of the drawings, the double entry slots 6 are located on the backside of the belt 1, cut parallel and at a one hundred and eighty (180) degree angle. The strap 3 fits into the top of the belt 1, on its backside, and is pulled through the first of the double entry slot 6. The final end one inch of the strap 3, approximately twice the thickness of the rest of the strap, is then slide into the second of the double entry slot 6. The added thickness to the end of the strap 3 will work to securely fasten the strap 3 to the belt 1, whereby securing the belt 1 to a seat.

In use, the head protector 5, once properly fastened by means of the elastic bands 7, as shown in FIG. 1, and strap 3, will serve to shield prolonged sitters from dangerous microbes contained within public seats. The head guard 2 will provide double-layer protection for the users, while also delivering an extra cushion for the user's head and neck. The pocket 4 is large enough to hold a user's cellphone, keys, or other small objects. The head protector 5 is disposable, so may be discarded after first use, or can be saved.

Not shown the in the drawings, an optional singular drape 8; wherein, said drape 8 is attached to the bottom-front of the belt 1 and hangs approximately 8 inches.

With respect to the above description, it is to be realized that the optimum dimensions, and their relationships, are to include variations in size, materials, shape, form, function and manner of operation, assembly and use.

7. (canceled)

8. (canceled)

1. A head-protecting device comprising: a covering; an attachment device coupled to said covering, said attachment device dimensioned to attach said covering to an article of furniture, said attachment device comprising a band of material having first end coupled to center-front portion of said covering and second end inserted into back portion of said covering.

2. The head-protecting device of claim 1 invention of claim 2 further comprising: wherein two elastic bands are dimensioned to secure the covering to an article of furniture.

3. The head-protecting device of claim 1 wherein said attachment device being a fabric material.

4. The head-protecting device of claim 1 and the attachment device of claim 3 further comprising: a two openings in the back of said cover; wherein said attachment device may be inserted into the top opening in the back of said covering and pulled through the bottom opening of said cover.

5. The head protecting device of claim 1 and the two openings of claim 4, further comprising: the end of said attachment device is twice the thickness to allow the end of said attachment device to be securely inserted into place through the invention of claim.

6. The head-protecting device of claim 1 which may further comprise: a singular pocket; wherein said pocket may be attached to the front of said covering.
